(19) United States
(12) Patent Application Publication
(10) Pub. No.: US 2022/0261240 A1
(43) Pub. Date: Aug. 18, 2022

(54) AGILE, AUTOMOTIVE SPICE, DEV OPS SOFTWARE DEVELOPMENT AND RELEASE MANAGEMENT SYSTEM

(71) Applicant: N. S. INTERNATIONAL, LTD., Troy, MI (US)

(72) Inventors: Akhtar Abbas, Troy, MI (US); Gary Kempen, Troy, MI (US); Preetham Prudhivi, Troy, MI (US); Vinu James, Troy, MI (US); Kangqing Zhao, Troy, MI (US)

(21) Appl. No.: 17/671,550

(22) Filed: Feb. 14, 2022

Related U.S. Application Data
(60) Provisional application No. 63/148,830, filed on Feb. 12, 2021.

(51) Int. Cl. G06F 8/71; G06F 8/77; G06F 11/36

(52) U.S. Cl. CPC G06F 8/71; G06F 11/3688; G06F 11/3684; G06F 8/77

(57) ABSTRACT

An automated software development and release management system. The system includes and compounds multiple quality gates along various check points and includes Key Performance Indicators (KPIs) to monitor progress and measure software quality. The system puts members of the software development team in the same place in the development cycle, which allows better and more efficient collaboration. The system enables the review of work products (i.e., instead of merely the process).

### RELATED APPLICATION (PRIORITY CLAIM)

The present application claims the benefit of U.S. Provisional Application Ser. No. 63/148,830, filed Feb. 12, 2021, which is hereby incorporated by reference in its entirety.

### FIELD OF THE INVENTION

The present invention generally relates to the field of software development. More particularly, the invention relates to automated systems for managing the development and release of software.

### BACKGROUND OF THE INVENTION

Conventional Embedded Systems Development methodologies (SDLC) are Supply Line Delivery model, where products are specified in one station, built/inspected/shipped in another station, and tested in another. The fundamental quality paradigm is Quality evaluation at end of cycle, with very little feedback loop between each station. This is partially due to manual delivery of work products, low level of automation and waterfall Project Management approach. Furthermore, Boundary lines between various types of testing (White box, grey box, verification, qualification, validation, integration) are often blurred with multiple teams duplicating test cases using similar test setups or big gaps in test areas due to cost or expertise overheads. The Quality approach used is quality through testing, instead of built-in quality. If Dev Ops approaches are used, they are only for SW in loop areas and System is often excluded from the loops. Bottom line is that conventional software development and release procedures are not very efficient, and oftentimes there are version control issues as well as other problems that result from the inefficiencies.

### SUMMARY OF THE DISCLOSURE

An embodiment of the present invention comprises an automated software development and release management system that includes and compounds multiple quality gates along various check points for SW Development, System Testing, Release and Defect Management Branches, making the feedback real time and efficient for every change injected into the system.

Another embodiment of the present invention comprises an automated software development and release management system that includes and compounds multiple quality gates along various check points for SW Development, System Testing, Release and Defect Management Branches, making the feedback real time and efficient for every change injected into the system.

Another embodiment of the present invention comprises an automated software development and release management system that includes and compounds multiple quality gates along various check points for system tester scoped branch, making the feedback real time and efficient for every change injected into the system.

Another embodiment of the present invention comprises an automated software development and release management system that includes and compounds multiple quality gates along various check points for main/release branch, making the feedback real time and efficient for every change injected into the system. This branch will always have the stable and release ready code at any time of software development life cycle.

Another embodiment of the present invention comprises an automated software development and release management system that includes and compounds multiple quality gates along various check points for main/release branch. Pre-release testing is streamlined at every stage before releasing the code.

Another embodiment of the present invention comprises an automated software development and release management system that includes a Dashboard with Key Performance Indicators (KPIs) to monitor progress and measure software quality.

Another embodiment of the present invention comprises an automated software development and release management system that is configured to put members of a software development team in the same place in the development cycle (as opposed to being spread out at various stages), thereby facilitating collaboration between multiple agile teams during the complete software development cycle.

Another embodiment of the present invention comprises an automated software development and release management system that is configured to enable the review of work products (i.e., instead of merely the process).

Another embodiment of the present invention comprises an automated software development and release management system that is configured to provide one or more (and preferably all) of the following: automated system testing, infrastructure as a code, platform design and testing, demarcation of testing areas, test case design review, continuous integration, automated traceability, and software/test cases being provided on the same tool.

### BRIEF DESCRIPTION OF THE FIGURES

FIG. 1 illustrates of the iterative life cycle flow of an automated software development and release management system which is in accordance with an embodiment of the present invention.

FIGS. 2A and 2B collectively illustrate (from left to right) release X (i.e., the current release) of the life cycle flow of FIG. 1 in more detail.

FIG. 3 is a flow chart that illustrates the Software Design Branch of the automated software development and release management system.

FIG. 4 is a flow chart that illustrates the Software Testing Branch of the automated software development and release management system.

FIG. 5 is a flow chart that illustrates the System Testing Branch of the automated software development and release management system.

FIG. 6 is a flow chart that illustrates the Main Branch of the automated software development and release management system

FIG. 7 is a flow chart that illustrates the Main Branch of the automated software development and pre-release management system

FIG. 8 illustrates a Hardware Architecture that can be used to implement the automated software development and release management system, across various teams (tiers in Automotive System) from OEM to the Development/Test teams.

FIG. 9 is like FIG. 8 but shows some additional components of the Hardware Architecture and the system in process.

### DETAILED DESCRIPTION OF AN EMBODIMENT OF THE INVENTION

While the present invention may be susceptible to embodiment in different forms, there is described herein in detail, a specific embodiment with the understanding that the present disclosure is to be considered an exemplification of the principles of the invention and is not intended to limit the invention to that described herein.

An embodiment of the present invention comprises an automated software development and release management system. The system preferably includes and compounds multiple quality gates along various check points, includes Key Performance Indicators (KPIs) to monitor progress and measure software quality. The system is configured to put members of an agile team in the same place in the development cycle, which allows better and more efficient collaboration. The system is preferably configured to enable the review of work products (i.e., instead of merely the process). The system is preferably configured to provide one or more (and preferably all) of the following: automated system testing, infrastructure as a code, platform design and testing, demarcation of testing areas, test case design review, continuous integration, automated traceability, and software/test cases being provided on the same tool.

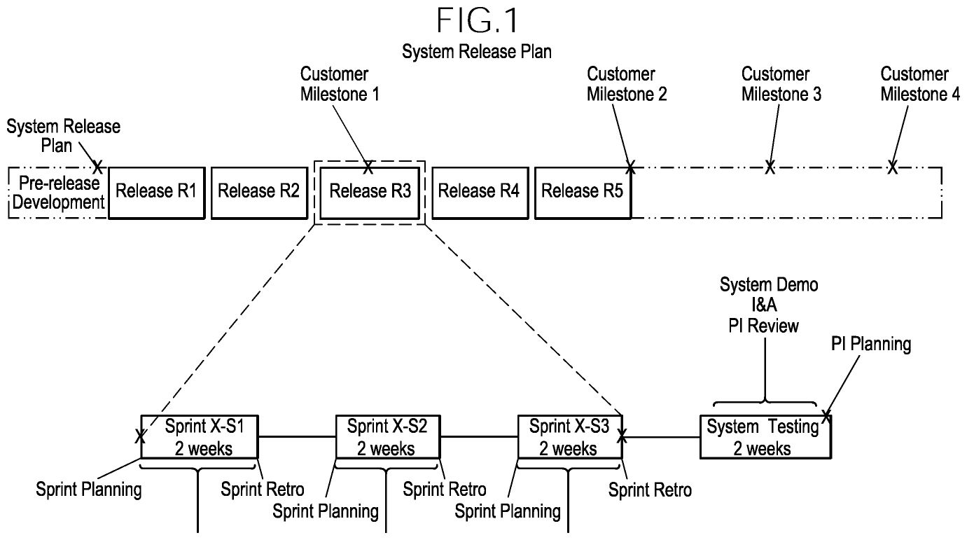

FIG. 1 illustrates of the iterative life cycle flow of an automated software development and release management system which is in accordance with an embodiment of the present invention.

The system provides that software is designed, developed, tested, and delivered in an agile, iterative, continuous integration and continuous delivery method using robust, automated tools in pipeline. The system is configured to effectively create workflows as a series of steps (requiring hardware, software, or human interaction) to plan, design, develop, and deploy software on automated Embedded ECUs using software quality metrics as KPIs.

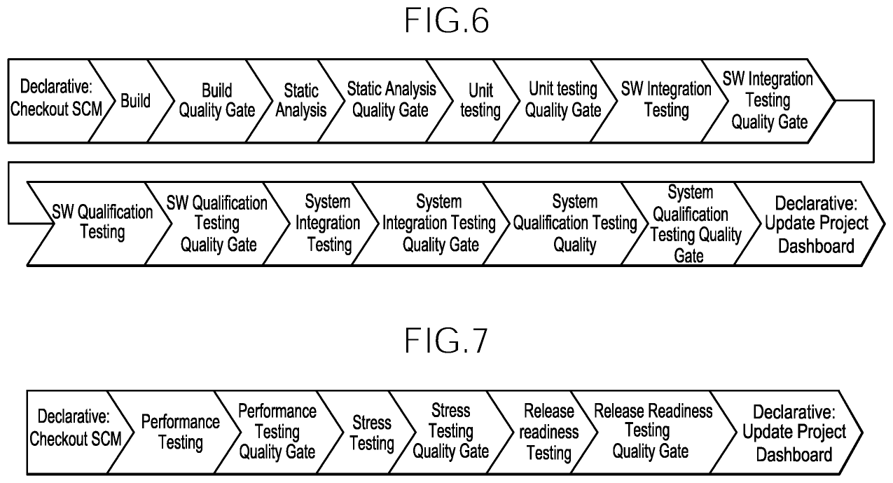

The system provides that initially there is an automated test-case-based feature roll out plan (derived from System Release Plan) where a team of engineers reviews the requirement specifications. Upon finalization of the specifications (aftermath of review activity), the team creates a test plan and tests cases based upon the specifications using test case generation tools. The team checks in those test cases on a database server (see FIGS. 5 and 6 which illustrate a Hardware Architecture that can be used). Those test cases are reviewed by the software team using a review tool and either sent back for clarifications and/or improvements or accepted for implementation as backlog or FROP. The backlog is then taken by teams for iterative planning, development, integration, and testing of software features.

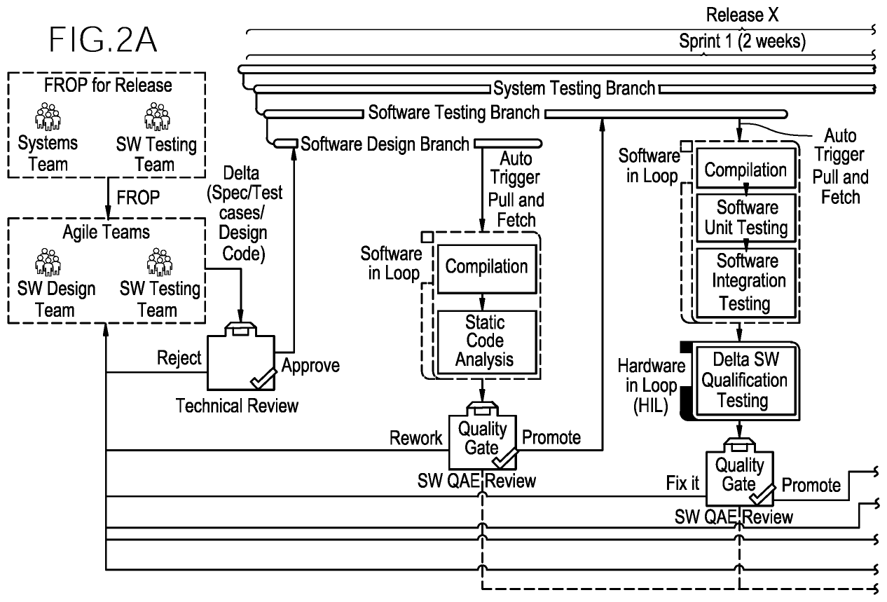

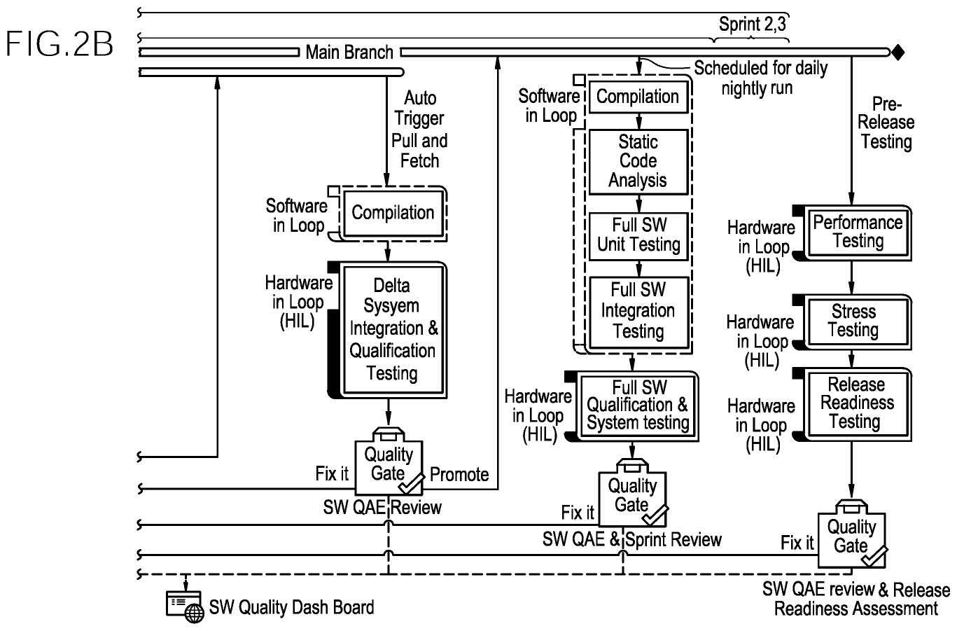

FIG. 1 illustrates the overall iterative life cycle flow, and FIG. 2 illustrates release X (i.e., the current release) of the life cycle flow of FIG. 1 in more detail. As shown in FIG. 2, each release may consist of three sprints, and each sprint may take two weeks. Sprint 4 is the Sprint used for System Demo, Inspection and Review.

As shown in FIGS. 2A and 2B (collectively from left to right), an online server containing physical and functional architecture contains and runs the code (i.e., infrastructure) that manages the development, testing, validation and release pipeline with automated script to build, test, and deliver software code using defined quality gates. System Team will create a System Release Plan based upon Customer Milestones. This System Release Plan will have task priorities and high-level Functions List. System Team will do the requirement Analysis of Customer Documents and created System Requirement Specifications. These specifications will have Requirements that will be used as Epics to assign to Software Team. Software team will review the Requirements and confirm implementation. Based upon this A Release Content (Epics) will be selected using Agile Backlog method and both Software and System teams will simultaneously start working on updating Design, Code, SW test cases, System Test cases. Periodically (such as every day), Software team and System team will check in latest code and test cases based upon the Release Content defined during Release Readiness Process. There will be three Repository Branches. Software Design Branch will trigger Auto Compilation, and Static Testing, using Software In Loop (SIL) every time a user checks in, in delta testing process. Once a Criterion is met, it will go to Software Testing Branch. Software Testing Branch will do run of Auto Compilation, Unit testing, Integration Testing and Qualification Testing using SIL. Once a Criterion is met, it will go to System Testing Branch. System Testing Branch will do the Delta System Testing using Hardware in Loop (HIL) setup. Once a Criterion is met, it will go to Main Branch. In Main Branch, daily night run is scheduled at run of Full Auto Compilation, Static Testing, Unit testing, Integration Testing using SIL, while there will be full System Testing using Hardware in Loop (HIL) setup. At the end of each Sprint there will be a Run of Performance testing, Stress Testing, and Release Readiness Testing. Based upon the Pre-Defined KPIs, a Release Readiness Process will ensure the System Release (Software/Hardware Configuration).

Along each step, an automated quality gate criterion evaluates the KPIs against defined parameters and rejects or promotes the code to subsequent testing (i.e., to the next delivery level).

Preferably, the quality gates and workflows are defined as follows: Compilation (Quality Gate 1); Static Testing (Quality Gate 2); Unit Testing (Quality Gate 3); Software Integration Testing (Quality Gate 4); Software Qualification Testing (Quality Gate 5); System Integration Testing (Quality Gate 6); System Qualification Testing (Quality Gate 7); Performance Testing (Quality Gate 8); Stress Testing (Quality Gate 9); Release Readiness Testing (Quality Gate 10); Customer Acceptance Testing Suite (Quality Gate 11).

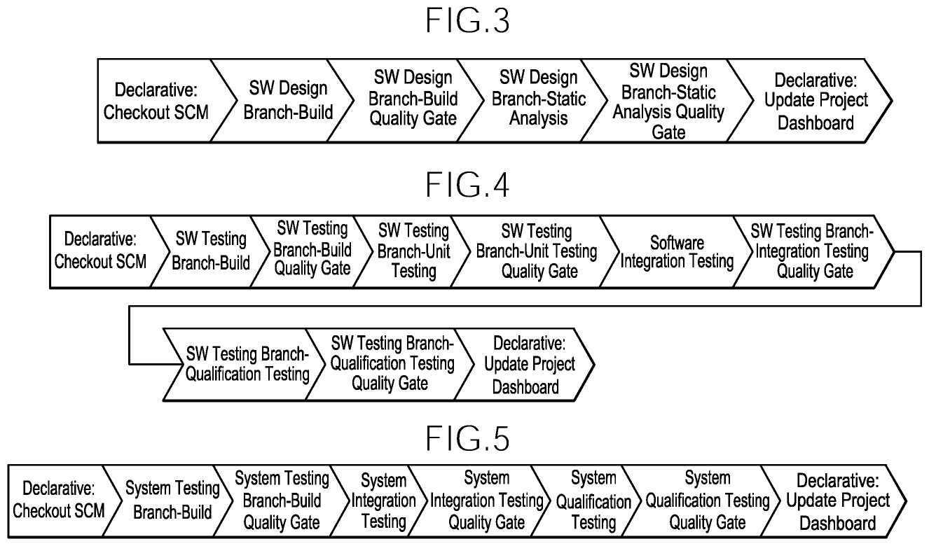

FIG. 3 is a flow chart that illustrates the Software Design Branch of the automated software development and release management system. For Trigger/Periodic based Runs, The Developer will check in New Code. Upon Quality Gate 1 (Compilation), Code will either demote(rework) to Developer or promote to Static Testing. Upon Quality Gate 2 (Static Testing), Code will either demote(rework) to Developer or Promote to Unit Testing. Upon Quality Gate 3, It will either demote (fix it) to Developer or it will generate a report with defined Parameters. Quality Gate will do further checks like level 5,7 warnings, Coverage rates. Infrastructure will send email to configured participants and the developer. For Nightly Runs, it will follow similar steps for Compilation, Static Testing, Unit testing, and SW Integration Testing, except instead of demoting it will log a ticket at each missed justification and go to Integration testing. Finally, It will do a Delta System Testing and do a log of failed test cases as a Ticket.

FIG. 4 is a flow chart that illustrates the Software Testing Branch of the automated software development and release management system. Once the code change is promoted from Software Design Branch, test cases for the corresponding code change will be created by the Software Test Team. Team will create and execute the Unit, Integration and Qualification test cases, will create a defect to track on any failures at any stage and send back to the developer team for fixing the same. Software Test Team will be involved in every design review stage, which Enhances the Work Quality and well-defined Judgement on creating and executing the test environment. Created qualification test cases are then tested on the HIL automatically through the pipeline.

FIG. 5 is a flow chart that illustrates the System Testing Branch of the automated software development and release management system. Once the test cases are promoted from Software Testing Branch, test cases for the corresponding code change will be created by the System Test Team. Team will create and execute the System Integration and Qualification test cases, will create a defect to track on any failures at any stage and send back to the developer team for fixing the same. Created test cases are then tested on the HIL automatically through the pipeline.

FIG. 6 is a flow chart that illustrates the Main Branch of the automated software development and release management system. Once the clean code is promoted from System Testing Branch, Main Branch will run a nightly automation on the full (clean build) system scope.

FIG. 7 is a flow chart that illustrates the Main Branch of the automated software development and pre-release management system. Clean (without any failures, refined at every stage before reaching main branch) code from Main Branch, Main Branch code ready for the release will go under regression testing under system scope. On every sprint/milestone the performance, stress and pre-release testing are performed on HIL through the pipeline.

Preferably, along the way, the KPIs are displayed at a central dashboard (i.e., “Quality Control Dashboard”) (shown in FIG. 2) to monitor project management, quality control, performance monitoring, test coverage and completion criterion.

Preferably, the system comprises the following components: automated test-case-based feature roll out plan; an agile iterative team structure for iterative planning, development, integration, and testing of software features; infrastructure of development, testing, validation and release pipeline with automated script to build, test, and deliver software code using defined quality gates; automated quality gate criterion at each critical phase to monitor the development and testing of KPIs against defined parameters and reject or promote the code to subsequent testing/delivery level; a Quality Control Dashboard to monitor project management, quality control, performance monitoring, test coverage and completion criterion; an agile sprint based approach towards content integration across multiple software providers to achieve a release pipeline consistent with the above; hardware architecture combining computers, Hardware in Loop, Software in Loop, servers, databases and network essentials to facilitate the above; software architecture including code, workflows, development tools, servers and planning tools to facilitate the above.

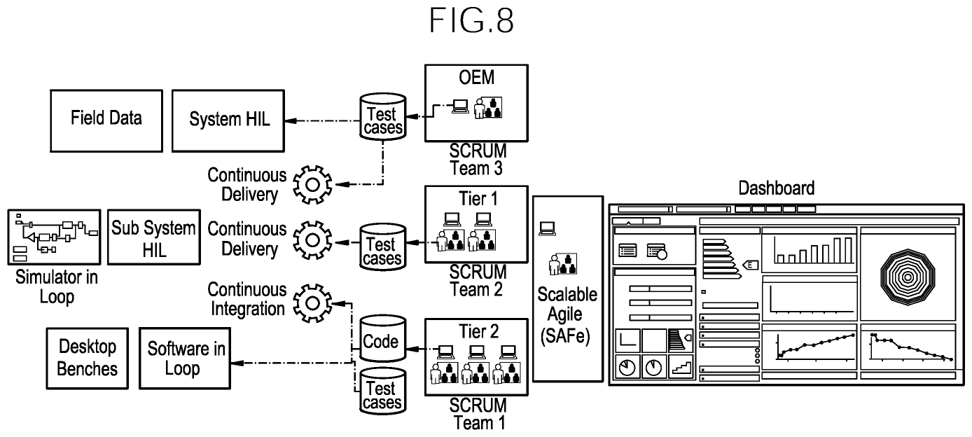

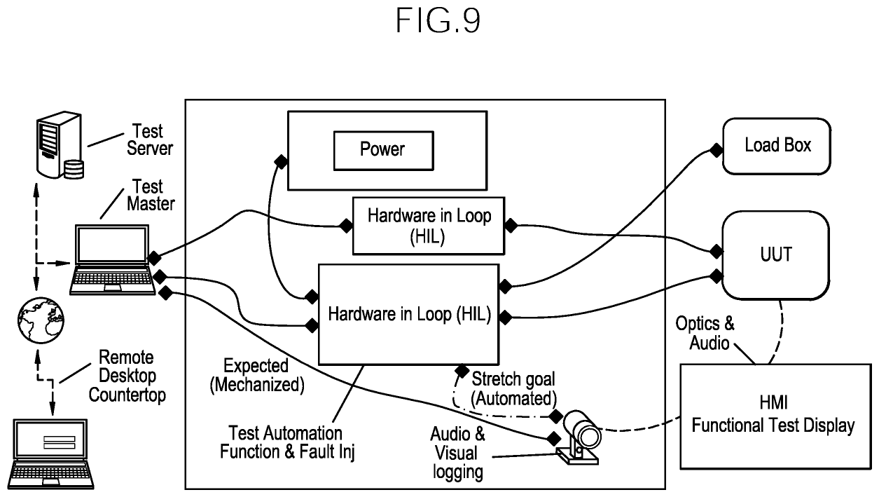

FIGS. 8 and 9 illustrate a Hardware Architecture that can be used to employ the system described herein. As shown, the architecture combines computers, Hardware in Loop, Software in Loop, servers, databases and certain network and server configurations are essentials.

While a specific embodiment of the invention has been shown and described, it is envisioned that those skilled in the art may devise various modifications without departing from the spirit and scope of the present invention.

What is claimed is:

1. A computer-implemented system for managing the development and release of software, said computer-implemented system comprising: a database server which runs software that causes the database server to receive input from a plurality of team members and implement multiple quality gates along various check points, wherein the system is configured to keep team members at the same check point until the database server determines that the software is ready to pass onto the next check point.

2. A computer-implemented system as recited in claim 1, wherein the system is configured to use software quality metrics to monitor progress and measure software quality.

3. A computer-implemented system as recited in claim 1, wherein the system is configured to enable the review of work products by the team members.

4. A computer-implemented system as recited in claim 1, wherein the system is configured to provide at least one of: automated system testing, infrastructure as a code, platform design and testing, demarcation of testing areas, test case design review, continuous integration, automated traceability, and software/test cases being provided on the same tool.

5. A computer-implemented system as recited in claim 1, wherein the system is configured to create workflows as a series of steps to plan, design, develop, and deploy the software using software quality metrics.

6. A computer-implemented system as recited in claim 1, wherein the database server is configured to receive test cases from one or more of the team members, wherein the system is configured such that the system is useable by team members to review the test cases using a review tool and then either: (a) designate the test cases for clarifications and/or improvements; or (b) accept the test cases for implementation.

7. A computer-implemented system as recited in claim 1, wherein the database server is configured to manage software development, testing, validation and release using automated script to build, test, and deliver the software using the quality gates.

8. A computer-implemented system as recited in claim 1, wherein the database server is configured to use an automated quality gate criterion to evaluate the software against defined parameters and reject or promote the software to subsequent testing.

9. A computer-implemented system as recited in claim 1, wherein the quality gates comprise: Compilation, Static Testing, Unit Testing, Software Integration Testing and Software Qualification Testing.

10. A computer-implemented system as recited in claim 9, wherein the quality gates also comprise System Integration Testing, System Qualification Testing and Performance Testing.

11. A computer-implemented system as recited in claim 10, wherein the quality gates also comprise Stress Testing, Release Readiness Testing and Customer Acceptance Testing Suite.

12. A method developing and releasing software, said method comprising using a computer-implemented system, wherein the computer-implemented system comprises a database server, said method comprising having team members provide input to the database server; having the database server implement multiple quality gates along various check points; and having the database server keep team members at the same check point until the database server determines that the software is ready to pass onto the next check point.
